(19) United States
(12) Patent Application Publication
(10) Pub. No.: US 2017/0118639 A1
(43) Pub. Date: Apr. 27, 2017

(54) WATCHES FOR USE IN TIME-DEPENDENT AUTHENTICATION SYSTEMS, AND METHODS OF USE THEREOF IN AUTHENTICATION PROTOCOLS

(71) Applicant: SCITEB LTD, London (GB)

(72) Inventor: Nicholas BEALE, London (GB)

(21) Appl. No.: 15/128,785

(22) PCT Filed: Mar. 25, 2015
(86) PCT No.: PCT/GB2015/050894

§ 371 Date: Sep. 23, 2016

(30) Foreign Application Priority Data
Mar. 25, 2014 (GB) 1405339.1

(51) Int. Cl. H04W 12/06; G04B 47/00; H04L 29/06

(52) U.S. Cl. CPC H04W 12/06; H04L 63/083; H04L 63/0492; G04B 47/00

(57) ABSTRACT

A watch (100) for use in a time-dependent authentication system, said watch (100) comprising: a mechanism having one or more moving components to measure and/or indicate passage of time, such as hands; a sensor subsystem (101, 102) configured to sense a mechanical configuration of said one or more moving components with respect to the fixed watch dial and to generate an output signal indicative of said sensed mechanical configuration; and a transmitter (107) configured to transmit said signal for use as a predictable, time-variant authentication token dependent on the mechanical configuration of the watch (100). In other words, the time-varying authentication token is related to the time-varying pattern formed by the positions of the hands onto the watch dial. The output signal is measured using a capacitive, an ultrasonic or an optical probe.

The present disclosure concerns watches for use in time-dependent authentication systems, and methods of use thereof in authentication protocols.

As lives and companies are increasingly digitised the secure authentication of access to information becomes increasingly vital. There is no perfect system: passwords can be hacked or stolen, fingerprints can be lifted and copied and other biometric systems such as iris scanners and face recognition can also be spoofed. A multi-factor approach offers the best security, whereby access to sensitive data is obtained by a combination of (say) knowledge of a passphrase, possession of a physical token (a key, card or other device) and some biometric criteria. However, carrying tokens is often inconvenient and they can be lost, stolen or borrowed to be cloned without the owner being immediately aware. Part of the problem is that most physical tokens are time-invariant so that observing (say) the pattern on a key at a particular time will allow the key to be cloned in a way that is effective at all subsequent times.

There is thus a user need for systems to provide secure authentication in a way that goes some way to addressing at least some of the shortcomings identified above.

According to the present disclosure a mechanical wristwatch is configured to function as a time-dependent authentication key. Wristwatches have the advantage that people habitually carry them attached to their person at almost all times and they are difficult to steal or “borrow” without the knowledge of the owner. They also have the advantage that they are complex mechanical devices whose behaviour varies in a time-dependent way, in which we also include of course date-dependence.

According to a first aspect, there is provided a watch for use in a time-dependent authentication system, said watch comprising: a mechanism having one or more moving components to measure and/or indicate passage of time; a sensor subsystem configured to sense a mechanical configuration of said one or more moving components and to generate an output signal indicative of said sensed mechanical configuration; and a transmitter configured to transmit said signal for use as a predictable, time-variant authentication token dependent on the mechanical configuration of the watch.

Said sensor subsystem could comprise a digitiser. The output signal could be digital.

Said authentication protocol could be a challenge-response protocol. The watch could further comprise a receiver configured to receive a challenge signal. The output signal could be transmitted in response to receipt of said challenge signal by said receiver.

The receiver and said transmitter could be comprised in a Bluetooth transceiver, an NFC transceiver, a WiFi transceiver, an RFID transceiver or a ZigBee transceiver.

The watch could be configured to perform a calibration protocol. Said sensor subsystem could sense the mechanical configuration of the watch at least intermittently over at least a 60 second period. Said transmitter could transmit signals indicative of the sensed mechanical configuration over said period to be remotely analysed and characterised in a secure computing environment.

Said period could be at least 60 minutes. Said period could be at least 12 hours. Said period could be at least 24 hours.

Said sensor subsystem could be provided as one or more modules or components retrofittable to a watch. Said transmitter could be provided as one or more modules or components retrofittable to a watch.

Said sensor subsystem could comprise one or more emitters configured to generate one or more probe signals. Said sensor subsystem could comprise one or more detectors configured to detect one or more altered probe signals, altered by the mechanical configuration of the watch, and use them to form the output signal.

Said one or more emitters and detectors could comprise one or more ultrasound emitters and detectors. Said one or more emitters and detectors could comprise one or more electromagnetic emitters and detectors.

Said sensor subsystem could comprise one or more detectors configured to passively generate the output signal.

Said one or more detectors could be configured to detect an electromagnetic interrogation signal from an electronic device.

Said one or more detectors could comprise capacitance sensors arranged to measure the capacitance between components of the watch whose relative locations change over time.

Said sensor subsystem could comprise a nanowire filament.

Said nanowire filament could be configured as, or as part of, one or more of: a capacitance sensor, an ultrasound transmitter, an infrared detector and a microwave antenna.

Said nanowire filament could comprise graphene.

Said sensor subsystem could be configured to combine outputs from a plurality of detectors to form the output signal.

The sensor subsystem could be configured to combine the sensed mechanical configurations from said plurality of detectors by performing one or more differencing or comparison operations.

The watch could further comprise one or more biometric sensors.

Said one or more biometric sensors could sense data from which can be determined one or more of: pulse, skin conductivity, gait, skin tone, epidermal ridge patterns, hair properties, microbiome, nerve impulses and genome.

Said authentication token could comprise data sensed by said one or more biometric sensors or data derived therefrom.

At least one of said one or more biometric sensors could be configured to sense a dynamic physiological signal. The authentication token could comprise amplitudes and/or widths of one or more peaks of said dynamic physiological signal, or one or more values derived therefrom.

At least part of said sensor subsystem could be, or could be mounted on, one of the moving components.

Said output signal could comprise time stamp data indicative of the time measured by the watch at the time of sensing the mechanical configuration of the watch.

According to a second aspect there is provided a system comprising the watch of the first aspect and an electronic device configured to receive the transmitted signal.

Said electronic device could be configured to transmit the challenge signal.

According to a third aspect there is provided a method performed by a watch in an authentication protocol, comprising: receiving a challenge signal; responsive to said receiving, sensing a mechanical configuration of one or more moving components of said watch; generating an output signal indicative of said sensed mechanical configuration; and transmitting said output signal for use as a predictable, time-variant authentication token dependent on the mechanical configuration of the watch.

The method could further comprise digitising the output signal before transmitting it.

Said receiving and transmitting could be performed by a Bluetooth transceiver, an NFC transceiver, a WiFi transceiver, an RFID transceiver or a ZigBee transceiver.

The method could further comprise a calibration protocol comprising: sensing the mechanical configuration of the watch at least intermittently over at least a 60 second period; and transmitting signals indicative of the sensed mechanical configuration over said period to be remotely analysed and characterised in a secure computing environment.

Said period could be at least 60 minutes. Said period could be at least 12 hours. Said period could be at least 24 hours.

The method could further comprise retrofitting a sensor subsystem to a watch to perform said sensing. The method could further comprise retrofitting a transmitter to a watch to perform said transmitting.

Said sensing could comprise generating one or more probe signals. Said sensing could comprise detecting one or more altered probe signals, altered by the mechanical configuration of the watch, and using them to form the output signal.

Said one or more probe signals could be ultrasound or electromagnetic signals.

Said sensing could be performed passively by one or more detectors.

Said passive sensing could comprise detecting an electromagnetic interrogation signal from an electronic device.

The passive sensing could comprise measuring the capacitance between components of the watch whose relative locations change over time.

Said sensing could use a nanowire filament.

The sensing could comprise said nanowire filament acting as, or as part of, one or more of: a capacitance sensor, an ultrasound transmitter, an infrared detector and a microwave antenna.

Said nanowire filament could comprise graphene.

Said generating could comprise combining outputs from a plurality of detectors to form the output signal.

Said combining could comprise performing one or more differencing or comparison operations.

The method could further comprise sensing one or more biometric indications.

Said one or more biometric indications could comprise data from which can be determined one or more of: pulse, skin conductivity, gait, skin tone, epidermal ridge patterns, hair properties, microbiome, nerve impulses and genome.

The method could further comprise incorporating said one or more biometric indications or data derived therefrom into said authentication token.

At least one of said biometric indications could be a dynamic physiological signal. The authentication token could comprise amplitudes and/or widths of one or more peaks of said dynamic physiological signal, or one or more values derived therefrom.

At least some of said sensing could be performed by one of the moving components or a component mounted thereon.

The method could further comprise processing the sensed signal indicative of the mechanical configuration to produce the authentication token.

Said output signal could comprise time stamp data indicative of the time measured by the watch at the time of sensing the mechanical configuration of the watch.

According to a fourth aspect there is provided a method comprising the method of the third aspect; and receiving the output signal at an electronic device.

The method could further comprise said electronic device transmitting said challenge signal.

The method could further comprise said electronic device using the output signal as an authentication token in an authentication protocol.

Said secure computing environment could be comprised in said electronic device.

The method could further comprise the electronic device receiving said signals indicative of the sensed mechanical configuration over the period. The method could further comprise the electronic device analysing the received signals to characterise the response of the watch in the secure computing environment.

The method could further comprise the electronic device using the secure characterisation of the response of the watch to authenticate said authentication token.

According to a fifth aspect there is provided a watch substantially as hereinbefore described with reference to any of the accompanying Figures.

According to a sixth aspect there is provided a system substantially as hereinbefore described with reference to any of the accompanying Figures.

According to a seventh aspect there is provided a method substantially as hereinbefore described with reference to any of the accompanying Figures.

As used herein, the phrase “moving components to measure and/or indicate passage of time” encompasses any moving components whose behaviour, configuration or properties depend in a deterministic manner on the passage of time.

Aspects of the present invention will now be described by way of example, with reference to the accompanying figures, in which:

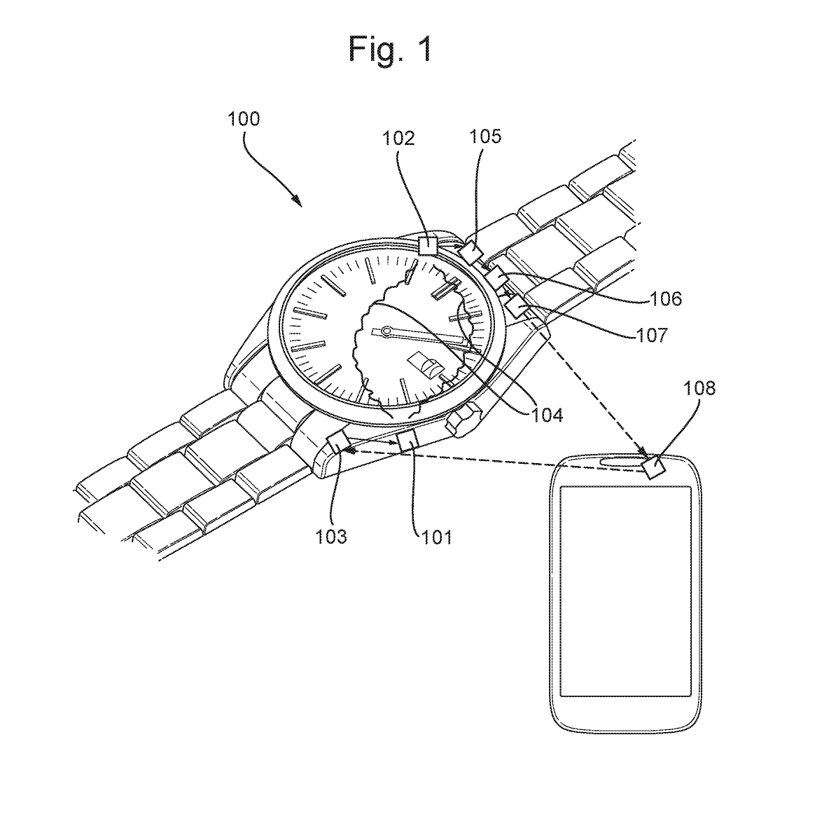

FIG. 1 illustrates a first example watch;

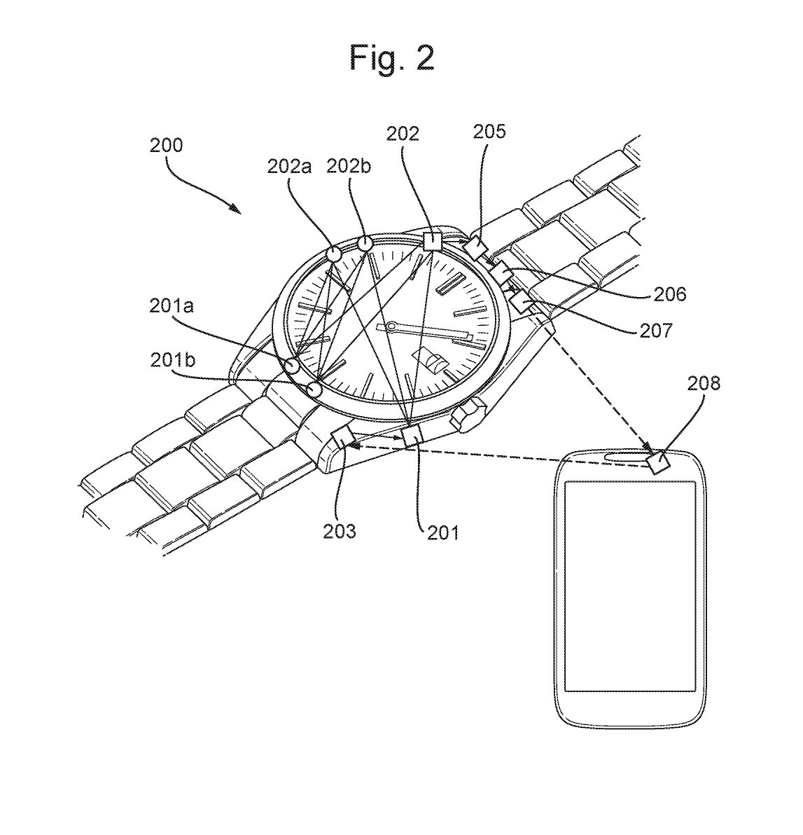

FIG. 2 illustrates a second example watch;

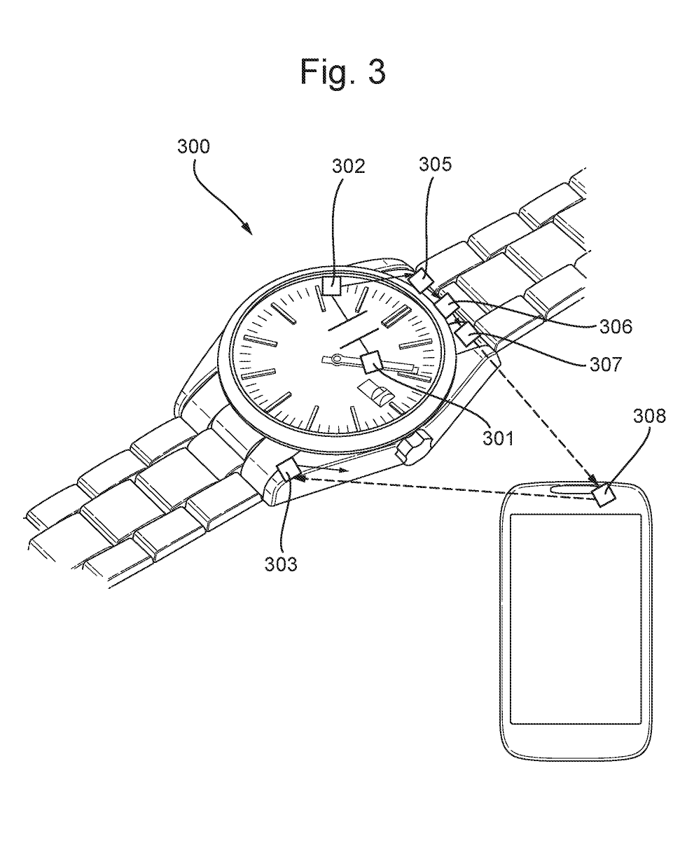

FIG. 3 illustrates a third example watch;

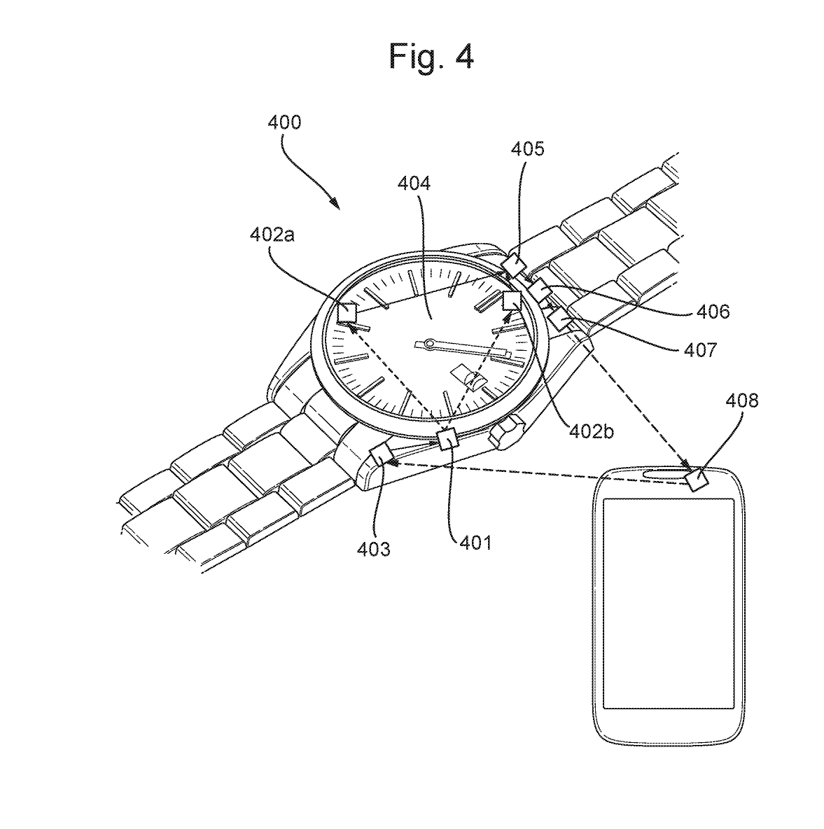

FIG. 4 illustrates a fourth example watch; and

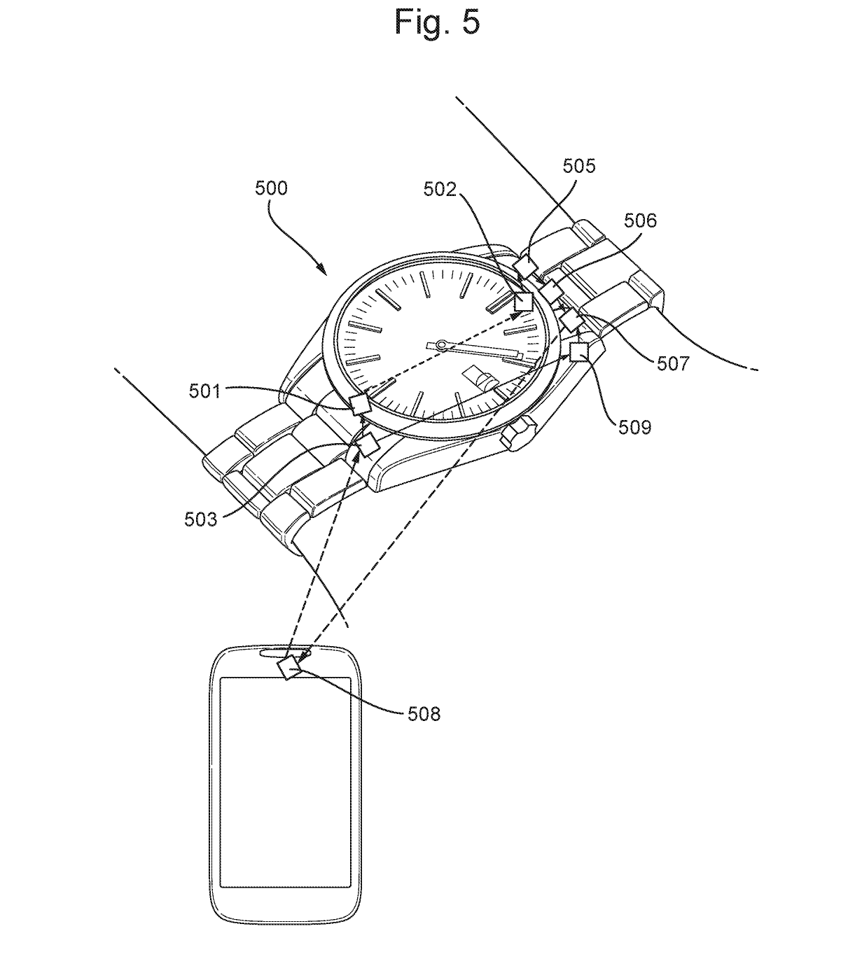

FIG. 5 illustrates a fifth example watch on a user's wrist.

Note that, in FIGS. 1 to 5 various emitters, sensors, transceivers etc. are shown schematically as associated with a watch. Their actual locations could suitably be within, on the surface of or otherwise connected to the watch.

There are a number of ways in which the watch can be implemented in order to provide a time-dependent signal for use in a secure authentication system.

Referring to FIG. 1, according to a first example a watch is provided with a mechanism having one or more moving components to measure and/or indicate the passage of time (i.e. the watch is not a purely digital one with no time-dependent moving parts).

The watch also includes a sensor subsystem comprising one or more emitters to generate one or more probe signals and one or more detectors to detect altered probe signals, altered by the mechanical configuration of the watch. The sensor subsystem is configured to sense a mechanical configuration of one or more moving components of the watch and to generate an output electrical signal indicative of the sensed mechanical configuration.

The watch also includes a transceiver subsystem configured to transmit the signal indicative of the sensed mechanical configuration for use as an authentication token in an authentication protocol, such as a challenge-response protocol.

In the sensor subsystem of the FIG. 1 example, a watch 100 is fitted with a sub-miniature ultrasonic piezoelectric transmitter 101 and a sensitive ultrasound receiver 102. When a suitable stimulus signal is received from a receiver 103 (which may be a near-field receiver) then the transmitter 101 emits a high frequency ultrasound signal 104 which travels through the interior of the watch and is received as a complex wave train by the receiver 102. The wavelength of the sound waves of interest would typically be of the order of 0.1 mm, which corresponds to a frequency of about 3 MHz, though higher frequencies could be used. The wave train is then digitised suitably through a digitiser 105 and transmitted by the transceiver back to the interrogating device 108 (mobile phone or computer or similar) through transmission means 107. This can either be done by transmitting the whole complex waveform that is received or by transmitting a digital signature created by a processor 106 from the waveform from digitisation means 105 which depends sensitively on the exact internal mechanical configuration of the watch. It is important that this signature depends in an exquisitely sensitive way on the details of the waveform received and cannot be simply predicted from the position of the hands on the watch. Note that the high frequency signal could either be a single “ping” or a more complex stimulus e.g. whose waveform depends on the signal sent to the near-field receiver 103. This could therefore mimic the “challenge and response” style of authentication used in electronic devices.

Referring to FIG. 2, according to a second example an electromagnetic signal, e.g. visible light, infrared or microwave, can be used instead of ultrasound. One or more tiny LEDs 201 and one or more sensitive light detectors (e.g. photodiodes) 202 are incorporated in the sensor subsystem inside the watch 200 in such a way that the optical path between 201 and 202 is dependent on the mechanical configuration of the watch. Again, when a suitable stimulus signal is received from a near-field receiver 203 then the transmitter 201 emits a burst of light which travels through the interior of the watch, being reflected off some surfaces and blocked by other solid parts, and is received by the receiver 202.

Because the speed of light is so much higher than the speed of sound it is unlikely that the detector 202 would be capable of resolving the differences in arrival times of the light travelling through different paths, and thus the observable in this case would not be a complex wave train but a single amplitude. However, 8 LEDs and 8 detectors would give 64 possible paths and thus a time-dependent signature of R+6 bits where R is the resolution of the Digital to Analogue conversion (typically 8 bits) with which the amplitude of the optical signal is digitised by digitiser 205. The digital response signal is transmitted back to the interrogating device 208 (mobile phone or computer or similar) through transmission means 207. This can either be done by transmitting one selected amplitude or all the amplitudes received or by processor 206 making a digital signature from the amplitudes received (if there is more than one sensor) which depends sensitively on the exact internal mechanical configuration of the watch. The stimulus could (in the case of multiple LEDs) select which LED is used and thus also mimic the “challenge and response” style of authentication used in electronic devices.

Referring to FIG. 3, a third example involves making a precise measurement of the electrical capacitance between two defined conductive surfaces in the watch. One of these might conveniently be the minute hand 301 and the other 302 could be placed asymmetrically with respect to the centre of the watch 300, for example the Train Wheel Bridge might be convenient. In response to receiving a signal from receiver 303 the capacitance of the capacitor formed between 301 and 302 is measured by capacitance measuring means 305 and digitised by digitiser 306 for transmission by transmission means 307 back to the interrogating phone or computer 308 or other device. Here, the configuration is detected passively, i.e. no stimulus signal or probe signal needs to be produced. The capacitance measuring means could for example be a capacitance meter or a tuned circuit comprising the capacitor of which the resonant frequency is measured.

Another passive sensing technique could use an interrogation signal emitted by the electronic device (e.g. a smartphone) proximate to the watch. A plurality of receivers (e.g. microantennae) in spaced apart relation in the watch could receive the interrogation signal, as modified by the current mechanical configuration of the watch. The differential received signal, i.e. a signal indicating the differences between the signals received by the various receivers, could be used to indicate that mechanical configuration.

Referring to FIG. 4, a further example is similar to the first example (with like reference numerals referring to like components) in that it uses ultrasound, but instead of simply measuring the signal received at one receiver from signal source 401 it determines the difference between the signal received at two receivers 402a and 402b which are located in different parts of the watch. This difference is exquisitely sensitive to the precise mechanical configuration within the watch and therefore provides a more precise discriminant of the particular watch model, configuration and time. Similar differential approaches can be applied to the other examples.

An additional layer of security could be added by incorporating one or more biometric sensors into the watch. Data from such sensors could be used to confirm the watch is being worn by an authorised user. Data collected by such biometric sensors, or derived therefrom, could be included in the authentication token for remote comparison with stored biometrics. Alternatively, such comparison could be carried out by a processor comprised in the watch. The result of the comparison could be indicated in the authentication token, or a successful biometric test could act as approval to transmit the authentication token; if the comparison finds the watch is not being worn by an authorised user transmission of the authentication token could be prevented.

Biometric sensors could for example be used to determine characteristic indicators of pulse, gait, skin or hair properties (e.g. conductivity, colour, thickness, epidermal ridge patterns), microbiome, nerve impulses or genome of the wearer.

If a dynamic physiological signal such as pulse is measured, relative amplitudes and/or widths of peaks could be determined to characterise the signal; for example the relative size and shape of the systolic and diastolic peaks.

FIG. 5 shows a further example watch (this time shown in use on a user's wrist) comprising a biometric sensor 509. Both emitter 501 and biometric sensor 509 are triggered by receipt of a challenge signal by receiver 503 from electronic device 508. Data is fed to transmitter 507 by sensors 509 and 502 (via digitiser 505 and processor 506) for communication of an authentication token to electronic device 508. Biometric sensor 509 is shown schematically; in a suitable implementation its location should be chosen appropriately for the parameter being sensed. For example, it may be located on the interior of the watch strap in the region a clasp or buckle is generally found so as to best measure a wearer's pulse, or on the underside of the watch face (on the surface contacting the user's skin) so as to best measure properties of the wearer's arm hair.

All of these techniques lend themselves to retrofitting in an existing watch, such as by providing the sensor subsystem and/or the transceiver subsystem in one or more retrofit modules or components.

Furthermore the precise arrangement of the internal transmitters and receivers can be kept secret so that, even if an attacker had very precise data about the watch that the target was wearing and was able to obtain an exact copy, they would not be able to predict the characteristics reliably enough without knowing the precise location and characteristics of the transmitters and the sensors.

Once the sensors and transmitters have been fitted to the watch and the watch has been re-sealed then the time-dependent characteristics of the watch can be measured and calculated for calibrations purposes. This could conveniently be done by, for example, observing the signals over a continuous 12 or 24 hour period and also observing the effect (if any) of changes in the date and other longer-term settings. The sensors and signal paths could be arranged so that the date dependence is either negligible or highly predictable. The information needed to identify whether the watch is making the correct response at any given time can then be installed in the phone or computer using appropriate cryptographic techniques.

One or more of the sensors could comprise a graphene filament, e.g. acting as an infrared detector, a capacitance sensor or as a conduit for ultrasonic vibrations to improve sensitivity of an ultrasonic detector arrangement.

One or more emitters and/or detectors could be located on moving components of the watch.

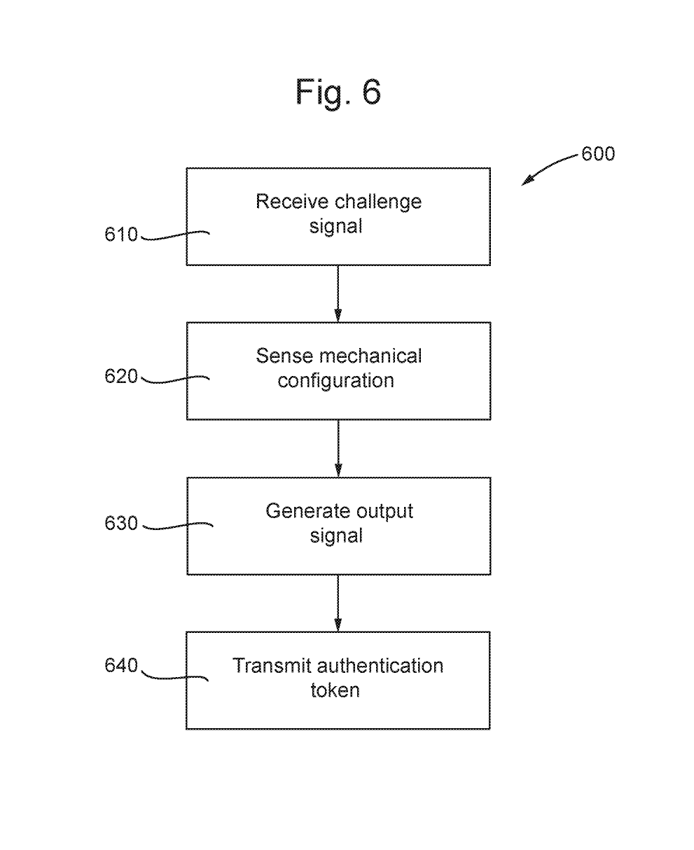

FIG. 6 is a flowchart of a method 600 performed by a watch in an authentication protocol. At 610 a challenge signal is received. At 620, responsive to said receiving, a mechanical configuration of one or more moving components of said watch is sensed. At 630 an output signal indicative of said sensed mechanical configuration is generated. At 640 said output signal is transmitted for use as a predictable, time-variant authentication token dependent on the mechanical configuration of the watch.

1. A watch for use in a time-dependent authentication system, said watch comprising:
a mechanism having one or more moving components to measure and/or indicate passage of time;
a sensor subsystem configured to sense a mechanical configuration of said one or more moving components and to generate an output signal indicative of said sensed mechanical configuration; and
a transmitter configured to transmit said signal for use as a predictable, time-variant authentication token dependent on the mechanical configuration of the watch.

2. The watch of claim 1, wherein said sensor subsystem comprises a digitiser and the output signal is digital.

3. The watch of claim 1, wherein:
said authentication protocol is a challenge-response protocol;
the watch further comprises a receiver configured to receive a challenge signal; and
the output signal is transmitted in response to receipt of said challenge signal by said receiver.

4. The watch of claim 3, wherein the receiver and said transmitter are comprised in a Bluetooth transceiver, an NFC transceiver, a WiFi transceiver, an RFID transceiver or a ZigBee transceiver.

5. The watch of claim 1, configured to perform a calibration protocol in which:
said sensor subsystem senses the mechanical configuration of the watch at least intermittently over at least a 60 second period; and
said transmitter transmits signals indicative of the sensed mechanical configuration over said period to be remotely analysed and characterised in a secure computing environment.

6. The watch of claim 5, wherein said period is at least 60 minutes, or at least 12 hours, or at least 24 hours.

7. The watch of claim 1, wherein said sensor subsystem and/or said transmitter are provided as one or more modules or components retrofittable to a watch.

8. The watch of claim 1, wherein said sensor subsystem comprises:
one or more emitters configured to generate one or more probe signals; and
one or more detectors configured to detect one or more altered probe signals, altered by the mechanical configuration of the watch, and use them to form the output signal.

9. The watch of claim 8, wherein said one or more emitters and detectors comprise one or more ultrasound emitters and detectors and/or one or more electromagnetic emitters and detectors.

10. The watch of claim 1, wherein said sensor subsystem comprises one or more detectors configured to passively generate the output signal.

11. The watch of claim 10, wherein said one or more detectors are configured to detect an electromagnetic interrogation signal from an electronic device.

12. The watch of claim 11, wherein said one or more detectors comprise capacitance sensors arranged to measure the capacitance between components of the watch whose relative locations change over time.

13. The watch of claim 1, wherein said sensor subsystem comprises a nanowire filament.

14. The watch of claim 13, wherein said nanowire filament is configured as, or as part of, one or more of: a capacitance sensor, an ultrasound transmitter, an infrared detector and a microwave antenna.

15. The watch of claim 13, wherein said nanowire filament comprises graphene.

16. The watch of claim 1, wherein said sensor subsystem is configured to combine outputs from a plurality of detectors to form the output signal.

17. The watch of claim 16, wherein the sensor subsystem is configured to combined the sensed mechanical configurations from said plurality of detectors by performing one or more differencing or comparison operations.

18. The watch of claim 1, further comprising one or more biometric sensors.

19. The watch of claim 18, wherein said one or more biometric sensors sense data from which can be determined one or more of: pulse, skin conductivity, gait, skin tone, epidermal ridge patterns, hair properties, microbiome, nerve impulses and genome.

20. The watch of claim 18, wherein said authentication token comprises data sensed by said one or more biometric sensors or data derived therefrom.

21-57. (canceled)
